(19) United States
(12) Patent Application Publication
(10) Pub. No.: US 2020/0355428 A1
(43) Pub. Date: Nov. 12, 2020

(54) METHOD FOR SYNTHESIS GAS PURIFICATION

(71) Applicants: Luke Coleman, Williamsville, NY (US); David Barnes, Keene, NH (US); Minish Mahendra Shah, East Amherst, NY (US); Khushnuma Koita, Plano, TX (US)

(72) Inventors: Luke Coleman, Williamsville, NY (US); David Barnes, Keene, NH (US); Minish Mahendra Shah, East Amherst, NY (US); Khushnuma Koita, Plano, TX (US)

(21) Appl. No.: 16/405,118

(22) Filed: May 7, 2019

(51) Int. Cl. F25J 3/02; B01D 53/04

(52) U.S. Cl. CPC F25J 3/0223; B01D 53/0462; C01B 2203/046; C01B 2203/042; F25J 2220/80; F25J 2290/44; F25J 2215/10; F25J 2215/14; F25J 2205/60

(57) ABSTRACT

The present invention relates to an integrated method and apparatus for providing a synthesis gas to a cryogenic separation unit installed for separating synthesis gas into products selected from carbon monoxide, crude hydrogen, methane-rich fuel and syngas with a particular H₂:CO ratio. More specifically, the invention relates to the purification of synthesis gas routed to a downstream cryogenic separation unit and minimizing temperature disturbances in the separation unit.

### BACKGROUND OF THE INVENTION

### Field of the Invention

The present invention relates to an integrated method and apparatus for providing a synthesis gas to a cryogenic separation unit installed for separating synthesis gas into products selected from carbon monoxide, crude hydrogen, methane-rich fuel and syngas with a particular H₂:CO ratio. More specifically, the invention relates to the purification of synthesis gas routed to a downstream cryogenic separation unit and minimizing temperature disturbances in the separation unit.

### Description of Related Art

The purification of synthesis gas (syngas), defined herein as a mixture comprised of at least H₂, CO, CO₂, CH₄, and H₂O, via cryogenic separation requires purification to remove substantially all H₂O and CO₂ from the syngas mixture. Failure to adequately remove H₂O and CO₂, as well as other species that form solids at sub-ambient conditions leads to fouling and plugging of the heat exchange and separation equipment that make up the cryogen separation unit. This ultimately leads to ineffective heat transfer and an increase in the pressure drop resulting in poor separation unit performance. The formation and accumulation of solids in the cryogenic separation unit is commonly known in the field as “freeze-up” and represents both an operational and safety risk to the plant. Much of the complexity in a conventional CO purification process is the result of purification to remove CO₂ and H₂O from the cryogenic separation unit feed syngas stream to avoid freeze-up.

The related art provides numerous examples of a conventional CO purification process including U.S. Pat. Nos. 4,732,596, 6,328,945 B1, and 7,066,984 B2 to Nicholas, Hufton and Dunn, respectively. In the conventional CO purification process, raw syngas is purified to effectively remove CO₂ and H₂O prior to being cryogenically separated. Bulk CO₂ removal from the raw syngas stream is achieved via a CO₂ scrubbing process unit utilizing an aqueous solution of monoethanolamine (MEA), methyldiethylamine (MDEA), or activated MDEA to reduce the CO₂ concentration from percent (%) levels to ppm levels. The treated syngas stream typically leaves the CO₂ removal unit saturated with water at a temperature of about 90 to 125° F. and at a pressure of between about 10 bar(a) and about 50 bar(a). To reduce the water content, the treated syngas stream can optionally be cooled to between 35 and 90° F., preferably 40 to 60° F., with liquid water being separated from the cooled, treated syngas stream in a gas-liquid separator prior to being further processed in a temperature-swing adsorption (TSA) process unit. The TSA process unit utilizes solid adsorbents (e.g., alumina, silica gel, molecular sieves including 3A, 4A, and 13X, alkali promoted alumina, which may be loaded in layers) to effectively remove of H₂O and CO₂ from the treated syngas stream. For all intents and purposes H₂O and CO₂ are removed from the syngas stream to levels below the detection limit of most conventional analyzers. Practically speaking, H₂O is typically removed to below 10 ppb, preferably less than 1 ppb, and CO₂ is typically removed to below 100 ppb, preferably less than 25 ppb. The TSA process unit, commonly referred to as a syngas dryer, plays the critical role of purifying the syngas stream to effectively eliminate H₂O and CO₂ and other species that form solids at cryogenic temperatures. The purified syngas stream substantially free of H₂O and CO₂ is then fed to a cryogenic separation unit resulting in the production of at least a purified CO product stream.

Syngas dryer process units inherently operate in a batch mode in where the adsorbent bed has a specific capacity to remove the desired contaminants and must be periodically regenerated, by at least heating the adsorbent bed and purging with a flowing gas, to remove the contaminants and restore the working capacity. The syngas dryer process unit consists of at least two adsorbent beds wherein each bed undergoes at least a feed phase for producing a synthesis gas substantially free of H₂O and CO₂ by adsorbing these components on the adsorbent bed and a regeneration phase to desorb H₂O and CO₂ from the adsorbent bed. Optionally, there could also be a standby phase wherein adsorbent bed is ready to transition to feed phase after having completed the regeneration phase.

In a syngas dryer process unit with more than two beds, additional adsorbent beds may be in a standby phase ready to be transitioned to the feed phase after having completed the regeneration phase. The additional adsorbent beds in the standby phase may be isolated from the feed, product, and regeneration gas streams or may process a small portion (e.g., 5-25%) of the feed stream as a means of ensuring that the adsorbent bed remains at the desired temperature during the standby phase. Processing a small portion of the feed stream during the standby phase can beneficially ensure that the adsorbent bed temperature is very close to the feed temperature thus reducing or eliminating temperature fluctuations in the product synthesis gas stream when the standby bed transitions to the feed phase. This can be particularly beneficial for TSA cycles in which the temperature of the freshly regenerated adsorbent bed completing the regeneration phase is greater than the temperature of the feed stream and in locations where the ambient temperature is significantly higher than the feed stream temperature.

The regeneration phase is comprised of at least a heating step and a cooling step with a process gas stream being used to provide heating and cooling to the adsorbent bed typically by flowing countercurrent to the direction to the feed stream. In syngas dryer process units, it is beneficial to use a synthesis gas stream substantially free of H₂O and CO₂, for example a portion of the syngas dryer product stream or a product synthesis gas stream from the cryogenic separation unit, as the regeneration gas. These benefits include high syngas recovery, no additional process gas streams (e.g., an inert gas), no introduction of impurities, a lower operating cost, and reduction or elimination of process disturbances including temperature or composition fluctuations to the downstream cryogenic separation units.

With reference to related art FIG. 1, the process and apparatus of a typical syngas dryer with product synthesis gas regeneration is explained and the main problems associated therewith are explained in detail. A syngas dryer process unit inclusive of a two-bed system (100, 200) for the substantial removal of H₂O and CO₂ from a synthesis gas feed stream (1) containing at least H₂, CO, CH₄, CO₂, and H₂O, typically from a pre-purification process unit such as a CO₂ removal system is provided. The two-bed system operates in such a manner that the feed stream (1) from an upstream pre-purification process unit can be fed to either adsorbent bed (100, 200). For purposes of explanation, adsorbent bed (100) is treating the feed stream (1) while the other adsorbent bed (200) is in the regeneration phase of the cycle and is being regenerated using a regeneration gas stream (11), which is formed by routing a regeneration portion (10) of the product stream (6) that is substantially free of H₂O and CO₂ through a compressor (400). A typical TSA cycle with product regeneration consists of seven primary steps: 1. Feed; 2. Pressurization (Press); 3. Heat; 4. Cool; 5. Depressurization (Depress); 6. Final Cooling; and 7. Blend. A TSA cycle chart describing the valve position for each step is provided in Table 1 to aid in description of the related art process shown in FIG. 1.

TABLE 1

| Adsorber | Adsorber | | | | | | | | | | | | | | | |
|---|---|---|---|---|---|---|---|---|---|---|---|---|---|---|---|---|
| 100 | 200 | 151 | 152 | 161 | 162 | 163 | 251 | 252 | 261 | 262 | 263 | 401 | 402 | 403 | 404 | 520 |
| Feed | Press | O | X | O | X | X | X | X | X | O | X | X | X | C/O | C | X |
| Feed | Heat | O | X | O | X | X | X | O | X | O | X | O | X | X | C | C |
| Feed | Cool-1 | O | X | O | X | X | X | O | X | O | X | O | X | X | C | X |
| Feed | Cool-2 | O | X | O | X | X | X | O | X | O | X | X | O | X | C | X |
| Feed | Depress | O | X | O | X | X | X | X | X | X | O | X | X | X | C | X |
| Feed | Final Cooling | O | X | O | X | X | O | X | X | X | O | X | X | X | C | X |
| Blend | Blend | O | X | O | X | X | O | X | O | X | X | X | X | X | C | X |
| Press | Feed | X | X | X | O | X | O | X | O | X | X | X | X | C/O | C | X |
| Heat | Feed | X | O | X | O | X | O | X | O | X | X | O | X | X | C | C |
| Cool-1 | Feed | X | O | X | O | X | O | X | O | X | X | O | X | X | C | X |
| Cool-2 | Feed | X | O | X | O | X | O | X | O | X | X | X | O | X | C | X |
| Depress | Feed | X | X | X | X | O | O | X | O | X | X | X | X | X | C | X |
| Final Cooling | Feed | O | X | X | X | O | O | X | O | X | X | X | X | X | C | X |
| Blend | Blend | O | X | O | X | X | O | X | O | X | X | X | X | X | C | X |

O = Open
X = Closed
C = Controlled
C/O = Controlled or Open

The cycle has been designed such that there are at least two phases—a feed phase and a regeneration phase. The feed phase spans the same amount of time as the regeneration phase—excluding the Blend step—and as such, after one adsorbent bed approaches its capacity for removing H₂O and CO₂, the feed stream (1) is directed to the freshly regenerated adsorbent bed leading to continuous production of a synthesis gas product stream (5) substantially free of H₂O and CO₂. In this embodiment, adsorbent bed (100) is in the Feed step and as such, valves (151) and (161) are open so that the feed stream (1) can flow through (100) and valves (251) and (261) are closed, thereby isolating adsorption bed (200) from the feed stream (1). Synthesis gas product stream (5), which is substantially free of H₂O and CO₂, exits adsorbent bed (100) and particulate matter is removed by a filter (380). Synthesis gas product stream (6) exiting the filter unit (380) is split into two portions. A portion is routed to the cryogen separation unit as cryogenic separation unit feed stream (7) and another portion is a regeneration gas stream (10). Stream (7) is directed to a cryogenic separation unit (not shown) for further separating H₂, CO, and CH₄. The regeneration gas stream (10), typically 10-25% by volume of stream (6), is utilized to regenerate the previously utilized adsorbent bed (200). The pressure of regeneration gas stream (10) is increased in a compressor (400) producing a regeneration gas (11) that has a pressure greater than the feed stream (1) such that it can be used for regeneration and be of a pressure sufficient to be returned to the process upstream of the said pre-purification unit.

In the pressurization (Press) step, adsorbent bed (200) is pressurized to the regeneration pressure by opening (262) and controlling the flow of regeneration gas (11) through (403). Once adsorbent bed (200) has reached a desired pressure and/or a predetermined time has elapsed, the cycle advances to the Heat step, and the corresponding valve actions depicted in Table 1 are executed. Specifically, valve (403) is closed, while valves (401), (262), and (252) are opened to allow regeneration gas stream (12) to flow through the regeneration gas heater (500) and the adsorbent bed (200). The compressed regeneration gas stream (12) is heated in regeneration gas heater (500) using superheated or saturated steam (510) to a temperature of between 66 and 752° F. (U.S. Pat. No. 4,472,178 (Kumar): 66-260° C. (150-500° F.); U.S. Pat. No. 4,636,225 (Klein): 100-200° C. (212-392° F.); U.S. Pat. No. 5,897,686 (Golden et al): 100-400° C. (212-752° F.)). Steam condensate exits regeneration gas heater (500) as stream (511). Syngas dryers that use a CO-containing gas for regeneration are prone to contamination of the regeneration system (i.e., regeneration gas heater, piping) and the product end of the adsorbent bed (i.e., adsorbent, vessel walls, and associated piping) with in-situ produced contaminants such as hydrocarbons, waxes, alcohols, aldehydes, carbonaceous deposits, CO₂, and H₂O that are formed via undesirable reactions with the main components of the regeneration gas—H₂ and CO—at elevated temperatures. The undesirable reaction products can irreversibly degrade the adsorbent's ability to remove H₂O and CO₂ and can contaminate the product end of the adsorbent bed and associated piping thus creating a pathway for contaminants to bypass the syngas dryer and be fed directly to the downstream cryogenic separation unit leading to accelerated freeze-up. As a result, the undesirable reaction products formed in the regeneration system can rapidly degrade dryer performance and ultimately reduce overall plant reliability due to more frequent freeze-up of the downstream cryogenic separation equipment in addition to more frequent adsorbent replacement. The formation of undesirable reaction products in a syngas stream on hot metallic surfaces is a well-known issue in the syngas processing field.

U.S. Pat. No. 4,559,207 to Hiller et al addressed the formation of contaminants in a methanol synthesis reactor by recommending the fabrication of the reactor and heat exchange tubes from austenitic steels (i.e., Cr-containing, stainless steels) to reduce the formation of hydrocarbon contaminants in the product methanol stream. Hiller et al discloses steels having a high austenite (i.e., chromium) content and low iron oxide content, such as stainless steels, have very little catalytic activity for producing undesirable reaction products in syngas streams. As such, to minimize the rate of the undesirable reactions in the regeneration system, the components in contact with hot syngas such as regeneration gas heater (500) and the piping between said gas heater (500) and the adsorbent beds (100, 200) are commonly constructed with austenitic (stainless) steels. In addition, it is known that the rate of formation of these contaminants increases exponential with temperature and, therefore, operating the heater at lower temperatures is preferred to reduce the rate of formation of these contaminants.

Hot regeneration gas stream (13) exiting regeneration gas heater (500) is fed to adsorbent bed (200) to heat the adsorbent in the vessel, thereby desorbing H₂O and CO₂. The H₂O and CO₂-laden regeneration gas exits adsorbent bed (200) passing through valve (252) as stream (25) before being returned upstream of the said pre-purification process as stream (14). The Heat step is continued for a predetermined length of time, the adsorbent bed (200) achieves a predetermined temperature, and/or until the temperature of the gas exiting the adsorbent bed (200) reaches a predetermined value. At this point, the Heat step is completed and the cycle advances to Cool-1 and the corresponding valve actions depicted in Table 1, above, are executed.

In the Cool-1 step, valve (520) is closed thereby stopping the flow of steam (or saturated steam) to regeneration gas heater (500) while the compressed regeneration gas (12) continues to flow through regeneration gas heater (500) via valve (401) as stream (13). A similar cooling heater cooling step has been described in U.S. Pat. Nos. 4,472,178; 4,784,672; and 4,971,606. As regeneration gas heater (500) cools, the rate of the undesirable reactions decreases to the point that the rate becomes essentially immeasurable. The Cool-1 step is continued for a predetermined length of time and/or until the temperature of the gas exiting the regeneration gas heater (500) reaches a predetermined value. It is preferred that regeneration gas heater (500) be allowed to cool to a temperature ranging from about 350-500° F. (or 300-450° F.) preferably <350° F., more preferably <250° F., and most preferably <200° F. to effectively halt undesirable reactions. With the completion of the Cool-1 step, the cycle advances to the next step referred to herein as Cool-2 and the corresponding valve actions depicted in Table 1 are executed. Valve (401) is closed to stop the flow of regeneration gas through regeneration gas heater (500) and valve (402) is opened to direct the compressed regeneration gas (11) to adsorbent bed (200) to cool the adsorbent bed and vessel. The temperature of the compressed regeneration gas (11) used for cooling is greater than the temperature of the feed gas (1) due at least to the heat of compression in compressor (400). Typically, the temperature rise associated with the heat of compression is between about 15 to about 45° F. As such, adsorbent bed (200) cannot be cooled to the temperature of the feed gas (1). Cool-2 is continued for a predetermined length of time, the adsorbent bed (200) achieves a predetermined temperature, and/or until the temperature of the gas exiting the adsorbent bed (200) is <30° F. greater than the temperature of the cooling gas.

With the completion of Cool-2, the cycle advances to the Depressurization (Depress) step and the corresponding valve actions depicted in Table 1 are executed and valves (252) and (262) are closed and valve (263) is opened. As described above, regeneration is performed at a pressure greater than the pressure of the feed gas (1). Pressure in adsorption bed (200) is equalized with the product syngas stream (5) by the release of gas through valve (263). The depressurization valve (263) is typically smaller than the feed and regeneration valves (261, 262) so that the adsorbent bed (200) depressurizes from the regeneration pressure to the product pressure in a manner that avoids damaging or fluidizing the adsorbent. The Depress step is continued for a predetermined length of time and/or until the pressure in adsorbent bed (200) reaches a predetermined value.

With the completion of the Depress step, the cycle advances to the Final Cooling step and the corresponding valve actions depicted in Table 1 are executed. Valve (251) is opened, allowing feed stream (1) to flow into and through the freshly regenerated adsorbent bed (200) and warm product syngas exits the bed through depressurization valve (263) and is combined with the product syngas stream (5). Meanwhile, adsorbent bed (100) continues to process the majority of the feed stream (1) as the depressurization valves (163, 263) are designed to be smaller than the feed valves (151, 152, 251, 252) and as such limits the flow of gas. Typically, depressurization valve (263) is sized such that between 3 and 10% of feed stream (1) can pass through adsorbent bed (200). The Final Cooling step is continued for a predetermined length of time and/or until trace contaminants (i.e., H₂O and/or CO₂) in the outlet of adsorbent bed (100) exceed a predetermined value. This completes the regeneration phase of the TSA cycle for adsorbent bed (200) and it is now ready to proceed to the feed phase.

The transition between the TSA cycle phases—feed to regeneration or regeneration to feed—is completed in a manner that reduces temperature fluctuations in the cryogenic separation unit feed stream (7) as a means of reducing disturbances in the downstream cryogenic separation. It is common practice to transition between phases with a Blend, or Parallel, step in which feed stream (1) is split and supplied to both adsorbent beds (100 and 200). Co-feeding or blending mitigates the extent of the temperature excursion in the syngas dryer product stream and therefore limits thermal disturbances in the downstream cryogenic separation unit. The cycle advanced from Final Cooling to the Blend step by completing the corresponding valve actions depicted in Table 1. Valve (261) is opened and valve (263) is closed so that approximately equal portions (2,22) of the feed gas (1) flows through both adsorbent beds (100) and (200) as streams (2) and (22). Alternatively, during blend step, valve (261) can be opened in incremental steps while valve (161) can be closed in incremental steps such that flow of feed stream (2) decreases and flow of stream (22) increases. The Blend step ensures a smooth transition, in terms of temperature and composition, as the freshly regenerated adsorbent bed (200) comes on-stream to treat the feed stream (1). The Blend step is continued for a predetermined length of time and/or the temperature of the product gas drops below a predetermined value, and/or until trace contaminants (i.e., CO₂ and/or H₂O) in the outlet of adsorbent bed (100) exceed a predetermined value.

With the completion of the Blend Step, the cycle advances and adsorbent bed (200) enters the Feed step and adsorbent bed (100) enters the regeneration phase of the cycle. While adsorbent bed (200) processes the feed stream (1), adsorbent bed (100) is regenerated following the steps described above.

By-pass valve (404) is in control mode throughout the cycle as it provides a means for the regeneration gas compressor (400) to operate continuously, which minimizes start/stop disturbances in the flow and composition of the syngas to the upstream and downstream separation units.

Syngas dryers, as described in the related art, are prone to introducing temperature disturbances and contaminants produced during the heat step of the regeneration phase to the downstream cryogenic separation unit during the depressurization (depress), final cooling, and blend steps. As discussed above, the temperature of the product gas exiting the freshly regenerated adsorbent bed during these steps can be about 15 to about 45° F. warmer than the product gas exiting the bed on feed. As such, the temperature of the cryogenic separation unit feed stream (7) can increase by between about 3 and about 25° F. depending upon the amount of gas passing through each of the beds. Although a transient effect, the temperature excursion persists until the adsorbent bed and vessel are cooled to the feed temperature, which usually spans about 10 to about 30% of the total cycle time depending upon the flow rate through the warm adsorbent bed during the final cooling and blend steps. Failing to cool the warm adsorbent bed to the feed temperature during the final cool step leads to a significant rise in the temperature excursion in the cryogenic separation unit feed stream (7) as the cycle proceeds to the Blend step since a larger portion of the cryogenic separation unit feed stream (7) comes from the freshly regenerated bed. Variations in the temperature of the cryogenic separation unit feed stream (7) results in thermal disturbances in the process heat exchangers, which are designed with very tight pinch points and approach temperatures, thus causing temperature fluctuations and instabilities in the vapor-liquid equilibrium in the numerous internal vapor and liquid streams. Ultimately, variations in the temperature of the cryogenic separation unit feed stream produces instabilities in the separation unit and reduces separation efficiency and CO product purity and recovery.

In addition to temperature disturbances, syngas dryers are susceptible to introducing contaminants produced in the regeneration system during the heating step, as described above, directly into the downstream cryogenic separation unit during the depressurization and final cooling steps. As described above, in-situ produced contaminants can accumulate and contaminate the regeneration system (i.e., regeneration gas heater, piping) and the product end of the adsorbent bed (i.e., adsorbent, vessel walls, and associated piping) creating a pathway for contaminants to bypass the syngas dryer and be fed directly to the downstream cryogenic separation unit leading to accelerated freeze-up.

To overcome the disadvantages of the related art, it is an object of the present invention to provide an integrated method and apparatus for a cryogenic separation unit, wherein the syngas dryer is designed to substantially reduce, if not outright eliminate the introduction of contaminants into the cryogenic separation unit and to minimize the temperature disturbances therein.

Other objects and aspects of the present invention will become apparent to one of ordinary skill in the art upon review of the specification, drawings and claims appended hereto.

### SUMMARY OF THE INVENTION

According to an aspect of the invention, a continuous purification method of a synthesis gas stream obtained from a pre-purification unit to remove substantially all H₂O and CO₂ prior to routing the synthesis gas product stream to a downstream cryogenic separation unit. The method includes:

supplying a synthesis gas feed stream to a synthesis gas purification unit comprised of at least two adsorbent beds undergoing a temperature swing adsorption (TSA) cycle where each bed undergoes at least two phases: (1) a feed phase for producing a synthesis gas product stream substantially free of H₂O and CO₂ by adsorbing these components on the adsorbent bed and (2) a regeneration phase to desorb H₂O and CO₂ from the adsorbent bed using a regeneration gas and routing the H₂O and CO₂-laden regeneration gas to upstream of the pre-purification unit, where said regeneration gas is formed by routing a regeneration portion of the synthesis gas product stream through a compressor, and

the regeneration phase of the TSA cycle comprising multiple steps including:

a pressurization step to increase the pressure of the adsorbent bed to be regenerated in a controlled manner using the regeneration gas;

a heating step to heat the regeneration gas in a heater and supplying it to the adsorbent bed to remove H₂O and CO₂ from the adsorbent bed;

a first cooling step in which heat addition to the heater stops while continuing the flow of the regeneration gas through the heater and the adsorbent bed;

a second cooling step to cool the adsorbent bed further with the regeneration gas while by-passing the heater;

a depressurization step in which the flow of regeneration gas to the adsorbent bed is stopped and the adsorbent bed is depressurized to the pressure of the product synthesis gas product stream in a controlled manner from a product end of the adsorbent bed;

and a final cooling step to cool the adsorbent bed to a temperature that is substantially the same as that of the synthesis gas feed stream by flowing a portion of the synthesis gas feed stream through the adsorbent bed;

wherein:

during the depressurization and final cooling steps, the gas stream exiting the adsorbent bed from the product end is combined with the regeneration gas stream portion of the synthesis gas product stream, and the combined mixture is compressed in the compressor to form a regeneration gas and the compressed mixture is routed to upstream of the pre-purification unit thus bypassing the adsorbent bed.

In another aspect of the invention, a continuous purification method of a synthesis gas to remove substantially all H₂O and CO₂ prior to routing said synthesis gas to a cryogenic separation unit is provided. The method includes:

supplying a synthesis gas feed stream obtained from a pre-purification unit to a synthesis gas purification unit comprised of at least two adsorbent beds undergoing a temperature swing adsorption (TSA) cycle where each bed undergoes at least two phases: (1) a feed phase for producing a synthesis gas product stream substantially free of H₂O and CO₂ by adsorbing these components on the adsorbent bed and (2) a regeneration phase to desorb H₂O and CO₂ from the adsorbent bed using a regeneration gas;

forming a regeneration gas stream by routing a regeneration portion of the synthesis gas product stream through a compressor where the regeneration gas stream is used to regenerate the adsorbent bed in the regeneration phase;

routing the regeneration gas leaving the adsorbent bed in the regeneration phase to upstream of the pre-purification unit;

stopping the flow of regeneration gas to the adsorbent bed after it is regenerated, depressurizing and introducing a portion of the synthesis gas feed stream to the second adsorbent bed to cool it to substantially the same temperature as the synthesis gas feed stream, wherein, during depressurization and subsequent cooling, the gas stream exiting the product end of the adsorbent bed is combined with the regeneration portion of the synthesis gas product stream and the combined gas mixture is compressed in the compressor forming the regeneration gas which is routed upstream of the pre-purification unit thus bypassing the regenerated bed.

In yet another embodiment of the invention, an integrated apparatus for continuous purification of a synthesis gas to remove substantially all H₂O and CO₂ prior to routing the synthesis gas product stream to a downstream cryogenic separation unit is provided. The apparatus includes:

a synthesis gas purification unit comprised of at least two adsorbent beds undergoing a temperature swing adsorption (TSA) cycle wherein the adsorbent beds alternately undergo a feed phase during which an adsorbent bed purifies a synthesis gas feed stream and produces a synthesis gas product stream substantially free of H₂O and CO₂ and a regeneration phase during which an adsorbent bed is regenerated using a regeneration portion of the synthesis gas product stream;

a conduit arrangement and valves for routing the synthesis gas product stream to a cryogenic separation unit;

a compressor and heater disposed in series;

a conduit for routing a regeneration portion of the synthesis gas product stream to the low-pressure side of the compressor to form a regeneration gas;

a conduit arrangement and valves for routing the regeneration gas through a heater, for by-passing the heater, and for routing the regeneration gas upstream of the pre-purification unit;

a conduit arrangement and valves for routing the regeneration gas to the product end of the adsorbent beds;

a conduit arrangement and valves for withdrawing gas from the feed end of the adsorbent beds and routing gas to upstream of the pre-purification unit; and

a conduit arrangement and valves for withdrawing a synthesis gas stream from the product end of the adsorbent beds and routing the gas stream to the conduit for routing a regeneration portion of the synthesis gas product stream to the low-pressure side of the compressor.

### BRIEF DESCRIPTION OF THE FIGURES

The objects and advantages of the invention will be better understood from the following detailed description of the preferred embodiments thereof in connection with the accompanying figure wherein like numbers denote same features throughout and wherein:

FIG. 1 is an illustrative flow sheet of a related art apparatus for syngas purification utilizing a syngas dryer product gas for regeneration.

FIG. 2 is an illustrative flow sheet of an integrated process and apparatus in accordance with an exemplary embodiment of the present invention for syngas purification using syngas dyer product gas for regeneration.

FIG. 3 is an illustrative flow sheet of an integrated process and apparatus in accordance with an exemplary embodiment of the present invention for a three-bed syngas purification using syngas dryer product gas for regeneration.

### DETAILED DESCRIPTION OF THE INVENTION

The present invention provides for a method and apparatus for improving the operation of a cryogenic separation unit producing at least a purified CO product stream by eliminating in-situ produced contaminants and temperature disturbances in the cryogenic separation unit feed stream that are the result of regenerating a temperature swing adsorption (“TSA”) unit. It will be understood by those skilled in the art, that the terms TSA, syngas dryer, and synthesis gas purification unit are utilized interchangeably. The improved process provides a means to cool the adsorbent bed without introducing warm gas to the downstream cryogenic separation unit, thus improving its performance. Further, it results in substantially less contaminants in the cryogenic separation unit feed stream and therefore eliminates the possibility of “freeze up” events.

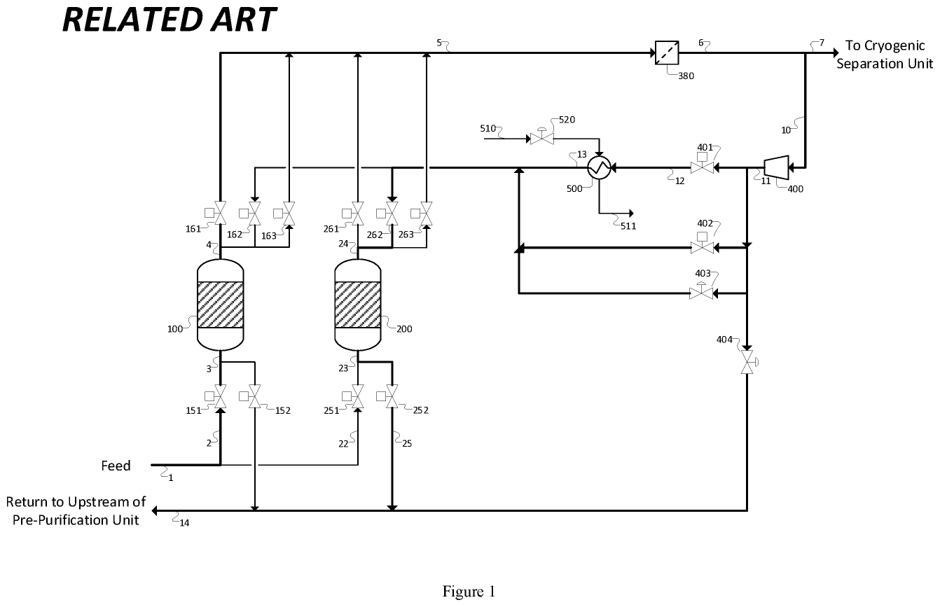

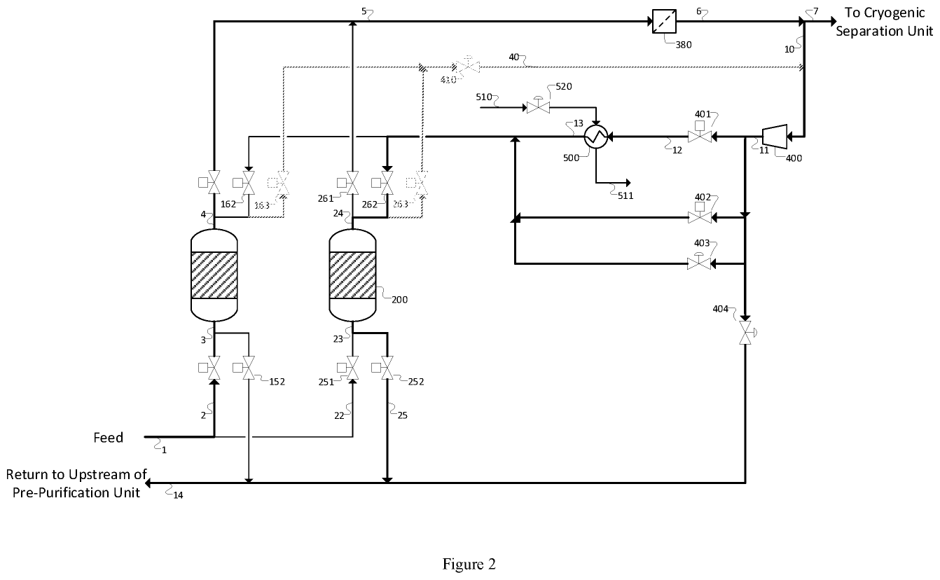

An exemplary embodiment of the present invention is that of a syngas dryer process unit with product gas regeneration for the production of a purified syngas stream to be fed to a cryogenic separation unit, as illustrated in FIG. 2. Similar to the related art syngas dryer process described above, the process shown in FIG. 2 utilizes a typical TSA cycle. The TSA cycle chart describing the valve positions for each step for the exemplary process shown in FIG. 2 is provided in Table 2, below. The inventive process flow sheet shown in FIG. 2 is similar to the related art flow sheet described in FIG. 1 with the exception of the conduit arrangement at the outlet of adsorption beds (100, 200), where valves (163, 263), which are opened during the Depress and Final Cooling steps, are connected with the regeneration gas portion of the TSA system through control valve (410). Similarly, the TSA cycles used for both processes are essentially the same except for the addition of the control valve (410), and the conduit system of FIG. 2, where the valves are operated as shown in Table 2. The syngas dryer processes shown in FIGS. 1 and 2 operate in essentially the same manner except for the beneficial modifications to the process particularly pertaining to the Depressurization (Depress) and Final Cooling steps that eliminate the introduction of contaminants into the cryogenic separation unit and minimize temperature disturbances therein during the Depressurization (Depress) and Final Cooling steps. For purposes of brevity, only the inventive aspects and the associated benefits of the novel process will be described in detail.

TABLE 2

| Adsorbent | Adsorbent | | | | | | | | | | | | | | | | |
|---|---|---|---|---|---|---|---|---|---|---|---|---|---|---|---|---|---|
| Bed | Bed | | | | | | | | | | | | | | | | |
| 100 | 200 | 151 | 152 | 161 | 162 | 163 | 251 | 252 | 261 | 262 | 263 | 401 | 402 | 403 | 404 | 410 | 520 |
| Feed | Press | O | X | O | X | X | X | X | X | O | X | X | X | C/O | C | X | X |
| Feed | Heat | O | X | O | X | X | X | O | X | O | X | O | X | X | C | X | C |
| Feed | Cool-1 | O | X | O | X | X | X | O | X | O | X | O | X | X | C | X | X |
| Feed | Cool-2 | O | X | O | X | X | X | O | X | O | X | X | O | X | C | X | X |
| Feed | Depress | O | X | O | X | X | X | X | X | X | O | X | X | X | C | C | X |
| Feed | Final Cooling | O | X | O | X | X | O | X | X | X | O | X | X | X | C | C | X |
| Blend | Blend | O | X | O | X | X | O | X | O | X | X | X | X | X | C | X | X |
| Press | Feed | X | X | X | O | X | O | X | O | X | X | X | X | C/O | C | X | X |
| Heat | Feed | X | O | X | O | X | O | X | O | X | X | O | X | X | C | X | C |
| Cool-1 | Feed | X | O | X | O | X | O | X | O | X | X | O | X | X | C | X | X |
| Cool-2 | Feed | X | O | X | O | X | O | X | O | X | X | X | O | X | C | X | X |
| Depress | Feed | X | X | X | X | O | O | X | O | X | X | X | X | X | C | C | X |
| Final Cooling | Feed | O | X | X | X | O | O | X | O | X | X | X | X | X | C | C | X |
| Blend | Blend | O | X | O | X | X | O | X | O | X | X | X | X | X | C | X | X |

O = Open
X = Closed
C = Controlled
C/O = Controlled or Open

In the preferred embodiment of this invention, the outlet of valve (410), stream (40), is beneficially introduced to the low-pressure side of the regeneration compressor (400) by routing this stream (40) and mixing same with a regeneration portion (10) of the synthesis gas product stream (6) utilized subsequently for regeneration. Naturally, stream (40) may have its particulates removed by routing through a filter (not shown). Thus, stream (40) is not combined with the product gas (5) as is practiced in the related art. This modification eliminates temperature disturbances in the downstream cryogenic separation unit by ensuring that the warm product gas exiting from the product end of the freshly regenerated bed during the Depress and Final Cooling steps is not combined with the cryogenic separation unit feed stream (7). Specifically, the gas exiting the adsorbent bed (200) from the product end is combined with the regeneration gas stream portion (10) of the synthesis gas product stream and the mixture is compressed in compressor (400) to form regeneration gas (11), wherein the compressed mixture is routed to upstream of the pre-purification unit (not shown), and bypassing the adsorbent bed. As such, the flow through the warm adsorbent bed can be increased to about 100% of the capacity of the regeneration gas compressor (400) during the final cooling step. This maximizes cooling rate of the warm adsorbent bed without affecting the temperature of the cryogenic separation unit feed stream. Further, this configuration effectively ensures that contaminants produced during regeneration and accumulated in the product end of the adsorbent bed and/or in the product end overhead space and piping are not introduced to the downstream cryogenic separation unit. The process and apparatus described herein provides a method for ensuring that the gases containing the said in-situ produced contaminants, particularly those produced by the freshly regenerated adsorbent bed during the Depressurization and Final Cooling steps, are not combined with the syngas dryer product gas and fed to the downstream cryogenic separation unit. Instead, the product gas from the Depressurization and Final Cooling steps is introduced to the low-pressure side of the regeneration gas compressor (400) and returned upstream of the pre-purification process where they can be removed/rejected from the process. This provides a means of rejecting the undesirable products from the process without degrading the performance of the downstream cryogenic separation unit.

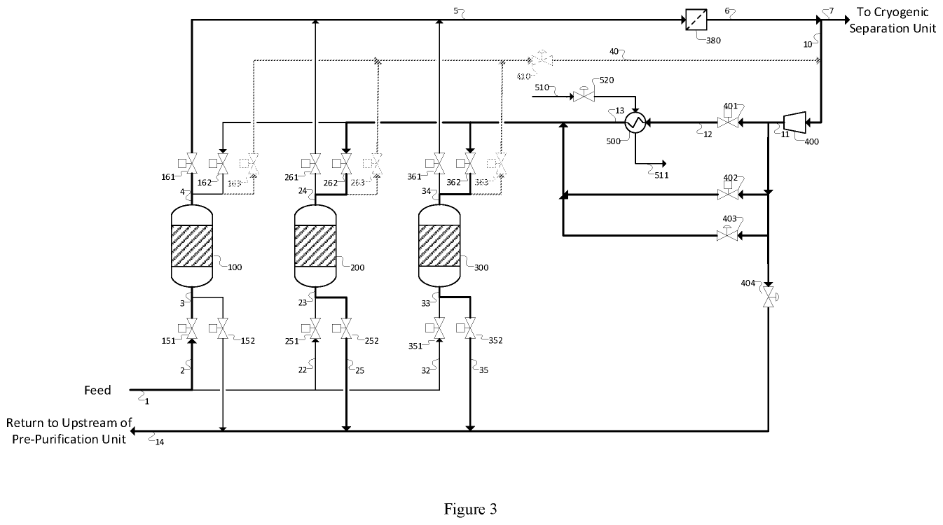

In another exemplary embodiment of the invention, a syngas dryer process consisting of three (3) adsorbent beds with product syngas regeneration for the production of a purified syngas stream to be fed to a cryogenic separation unit is illustrated in FIG. 3. The three (3) bed system is very similar to the two (2) bed system described above with the notable additions of the adsorbent bed (300) and the associated valves (351, 352, 361, 362, 363) with no changes to the rest of the system. The 3-bed system operates a standard TSA cycle, which is very similar to that of the 2-bed systems described in relation to FIG. 2, with the addition of a Standby phase. An exemplary TSA cycle chart describing the valve position for each step for the 3-bed syngas dryer process unit shown in FIG. 3 is provided in Table 3, below. In this example, the TSA cycle phases follow the order: Feed—Regeneration—Standby. The Feed and Regeneration phases of the cycle remain the same as for the two-bed process described above. As such, for brevity, only the transition of adsorbent bed (300) in to and out of the Standby phase is described. With the completion of the Final Cooling step, the TSA cycle proceeds and the freshly regenerated bed (300) enters the Standby phase and the adsorbent beds in the Standby (200) and Feed (100) phases enter the Blend step as the transition between Feed and Regeneration phases. The corresponding valve actions are depicted in Table 3, below. In this embodiment, a portion of the feed syngas is passed through the adsorbent bed (300) during the Standby phase to continue cooling the bed to the temperature of the feed stream (1) and/or to ensure that the bed remains at or near the temperature of the feed stream during the Standby phase and as such the valves associate with adsorbent bed (300) remain unchanged. At the same time, adsorbent bed (200) transitions from the Standby phase to the Feed phase by transitioning from the Standby step to the Blend step. The corresponding valve actions are depicted in Table 3. Valve (261) is opened and valve (263) is closed so that the feed stream (1) flows through both adsorbent beds (100) and (200). The Blend step ensures a smooth transition, in terms of temperature and compositional variations, as adsorbent bed (200) comes on-stream to treat the feed syngas (1). One notable difference between the 2-bed and 3-bed systems is that gas flows continuously through valve (410) and as such it is in control mode throughout the entire cycle. In addition to the benefits described above for the 2-bed system, the 3-bed system described herein has the benefit of a stable cryogenic separation unit feed temperature particularly during the Depressurization, Final Cooling, and Blend steps.

TABLE 3

| Ad- | Ad- | Ad- | | | | | | | | | | | | | | | | | | | | | |
|---|---|---|---|---|---|---|---|---|---|---|---|---|---|---|---|---|---|---|---|---|---|---|---|
| sorber | sorber | sorber | | | | | | | | | | | | | | | | | | | | | |
| 100 | 200 | 300 | 151 | 152 | 161 | 162 | 163 | 251 | 252 | 261 | 262 | 263 | 351 | 352 | 361 | 362 | 363 | 401 | 402 | 403 | 404 | 410 | 520 |
| Feed | Standby | Press | O | X | O | X | X | O | X | X | X | O | X | X | X | X | O | X | X | C/O | C | C | X |
| Feed | Standby | Heat | O | X | O | X | X | O | X | X | X | O | X | O | X | O | X | O | X | X | C | C | C |
| Feed | Standby | Cool-1 | O | X | O | X | X | O | X | X | X | O | X | O | X | O | X | O | X | X | C | C | X |
| Feed | Standby | Cool-2 | O | X | O | X | X | O | X | X | X | O | X | O | X | O | X | X | O | X | C | C | X |
| Feed | Standby | Depress | O | X | O | X | X | O | X | X | X | O | X | X | X | X | O | X | X | X | C | C | X |
| Feed | Standby | Final | O | X | O | X | X | O | X | X | X | O | O | X | X | X | O | X | X | X | C | C | X |
| | | Cooling | | | | | | | | | | | | | | | | | | | | | |
| Blend | Blend | Standby | O | X | O | X | X | O | X | O | X | X | O | X | X | X | O | X | X | X | C | C | X |
| Press | Feed | Standby | X | X | X | X | O | O | X | O | X | X | O | X | X | X | O | X | X | C/O | C | C | X |
| Heat | Feed | Standby | X | O | X | O | X | O | X | O | X | X | O | X | X | X | O | O | X | X | C | C | C |
| Cool-1 | Feed | Standby | X | O | X | O | X | O | X | O | X | X | O | X | X | X | O | O | X | X | C | C | X |
| Cool-2 | Feed | Standby | X | O | X | O | X | O | X | O | X | X | O | X | X | X | O | X | O | X | C | C | X |
| Depress | Feed | Standby | X | X | X | X | O | O | X | O | X | X | O | X | X | X | O | X | X | X | C | C | X |
| Final | Feed | Standby | O | X | X | X | O | O | X | O | X | X | O | X | X | X | O | X | X | X | C | C | X |
| Cooling | | | | | | | | | | | | | | | | | | | | | | | |
| Standby | Blend | Blend | O | X | X | X | O | O | X | O | X | X | O | X | O | X | X | X | X | X | C | C | X |
| Standby | Press | Feed | O | X | X | X | O | X | X | X | X | O | O | X | O | X | X | X | X | C/O | C | C | X |
| Standby | Heat | Feed | O | X | X | X | O | X | O | X | O | X | O | X | O | X | X | O | X | X | C | C | C |
| Standby | Cool-1 | Feed | O | X | X | X | O | X | O | X | O | X | O | X | O | X | X | O | X | X | C | C | X |
| Standby | Cool-2 | Feed | O | X | X | X | O | X | O | X | O | X | O | X | O | X | X | X | O | X | C | C | X |
| Standby | Depress | Feed | O | X | X | X | O | X | X | X | X | O | O | X | O | X | X | X | X | X | C | C | X |
| Standby | Final | Feed | O | X | X | X | O | O | X | X | X | O | O | X | O | X | X | X | X | X | C | C | X |
| | Cooling | | | | | | | | | | | | | | | | | | | | | | |
| Blend | Standby | Blend | | | | | | | | | | | | | | | | | | | | | |

O = Open
X = Closed
C = Controlled
C/O = Controlled or Open

The invention is further explained through the following example, which compare the related TSA process with the one based on exemplary embodiments of the invention, which are not to be construed as limiting the present invention.

### Comparative Example

A raw syngas stream exiting a pre-purification unit consisting an aqueous-amine CO₂ removal system and a chiller/separator unit is fed to a syngas dryer process unit (i.e., TSA) for the substantial removal of H₂O and CO₂. The raw syngas stream having a composition of 64.8% H₂, 33.5% CO, 1.1% CH₄, 50 ppm CO₂, 554 ppm H₂O, and 0.5% inerts (N2+Ar) enter the syngas dryer process as stream (1) in FIGS. 1 and 2 at a rate of 181 MMscfd and at 50° F. and 392.7 psia. The adsorbent beds (100, 200) contain 128,000 lbs of a 13× adsorbent. Following the TSA cycle described above, the raw syngas stream is fed to adsorbent bed (100) for the substantial removal of CO₂ and H₂O. The purified gas exits the adsorbent bed containing <10 ppb CO₂ and <1 ppb H₂O at a slightly elevated temperature of 52° F. and is fed as stream (7) to the downstream cryogenic separation unit. The small increase in the purified gas temperature is associated with heat released during adsorption of H₂O and CO₂ and heat gained from the environment. Adsorbent bed (200), having just completed the Cool-2 step, has a mean bed temperature of about 90° F. As the cycle proceeds to the Depressurization step, warm product gas is released from adsorbent bed (200). In the related art process described above and shown in FIG. 1, the warm product syngas from adsorbent bed (200) is combined with the purified gas exiting adsorbent bed (100) and fed directly to the downstream cryogenic separation unit. Only a small amount of gas exits the warm adsorbent bed (200) during the Depressurization step causing little variation in the combined feed gas stream. However, as the cycle proceeds to the Final Cooling step, in which for this comparative example 16% of the feed gas is introduced to the warm adsorbent bed (200), the temperature of the syngas dryer product stream (6) to the cryogenic separation unit increases rapidly to 57.0° F. The fraction of feed gas passing through the warm adsorbent bed was set based on the regeneration flow rate for this example. The temperature excursion remains until the adsorbent bed temperature is reduced to the feed temperature, which can last several hours, typically from about 20 to about 60% of the total regeneration phase time. In this comparative example, the temperature excursion lasts for approximately 3.5 hours. This method effectively transfers the residual heat in the adsorbent bed at the end of the Cool-2 step into the downstream cryogenic separation unit.

In the inventive process shown in FIG. 2, the gas exiting the warm adsorbent bed (200) during the Depressurization and Final Cooling steps is not combined with the cryogenic separation unit feed stream (7) and instead this stream (40) is combined with the regeneration gas stream (10) and directed to the low-pressure side of the regeneration gas compressor (400). As such there is no variation in the temperature of the cryogenic separation unit feed stream. It remains unchanged at 52° F. In this exemplary embodiment of the present invention, an effective means of avoiding the introduction of a temperature disturbance in the downstream cryogenic separation unit caused by the cooling of the freshly regenerated adsorbent bed is provided. Instead of transferring heat from the adsorbent to the downstream cryogenic separation unit as is done in the comparative example of the related art, the described invention provides a means of rejecting the residual heat to the upstream process which is unaffected by the variation in the temperature of the returned regeneration gas (14).

While the invention has been described in detail with reference to specific embodiments thereof, it will become apparent to one skilled in the art that various changes and modifications can be made, and equivalents employed, without departing from the scope of the appended claims.

What is claimed is:

1. A continuous purification method of a synthesis gas stream obtained from a pre-purification unit to remove substantially all H₂O and CO₂ prior to routing the synthesis gas product stream to a downstream cryogenic separation unit comprising:
supplying a synthesis gas feed stream to a synthesis gas purification unit comprised of at least two adsorbent beds undergoing a temperature swing adsorption (TSA) cycle where each bed undergoes at least two phases: (1) a feed phase for producing a synthesis gas product stream substantially free of H₂O and CO₂ by adsorbing these components on the adsorbent bed and (2) a regeneration phase to desorb H₂O and CO₂ from the adsorbent bed using a regeneration gas and routing the H₂O and CO₂-laden regeneration gas to upstream of the pre-purification unit, where said regeneration gas is formed by routing a regeneration portion of the synthesis gas product stream through a compressor, and the regeneration phase of the TSA cycle comprising multiple steps including:
a pressurization step to increase the pressure of the adsorbent bed to be regenerated in a controlled manner using the regeneration gas;
a heating step to heat the regeneration gas in a heater and supplying it to the adsorbent bed to remove H₂O and CO₂ from the adsorbent bed;
a first cooling step in which heat addition to the heater stops while continuing the flow of the regeneration gas through the heater and the adsorbent bed;
a second cooling step to cool the adsorbent bed further with the regeneration gas while by-passing the heater;
a depressurization step in which the flow of regeneration gas to the adsorbent bed is stopped and the adsorbent bed is depressurized to the pressure of the product synthesis gas product stream in a controlled manner from a product end of the adsorbent bed;
and a final cooling step to cool the adsorbent bed to a temperature that is substantially the same as that of the synthesis gas feed stream by flowing a portion of the synthesis gas feed stream through the adsorbent bed;
wherein:
during the depressurization and final cooling steps, the gas stream exiting the adsorbent bed from the product end is combined with the regeneration gas stream portion of the synthesis gas product stream, and the combined mixture is compressed in the compressor to form a regeneration gas and the compressed mixture is routed to up-stream of the pre-purification unit thus bypassing the adsorbent bed.

2. The continuous purification method of claim 1, wherein the synthesis gas feed stream obtained from a pre-purification unit has a pressure of about 10 bar(a) to about 50 bar(a).

3. The continuous purification method of claim 1, wherein the synthesis gas feed stream obtained from a pre-purification unit has a temperature of about 35° F. to about 125° F.

4. The continuous purification method of claim 1, wherein the regeneration portion used for regeneration is between 0% and 25% of the synthesis gas product stream.

5. The continuous purification method of claim 1, wherein the portion used for final cooling is between 5% and 25% of the synthesis gas feed stream.

6. The continuous purification method of claim 1, where the synthesis gas purification unit is a two-bed system where one bed is under a feed phase and other bed is under a regeneration phase.

7. The continuous purification method of claim 1, further comprising an additional stand-by phase where each adsorbent bed undergoes a feed phase, a regeneration phase and a stand-by phase in that order.

8. The continuous purification method of claim 1, wherein the regeneration gas stream is heated to about 225-500° F. in the heater.

9. The continuous purification method of claim 8, wherein the regeneration gas stream is heated to about 300-450° F. in the heater.

10. The continuous purification method of claim 7, wherein the synthesis gas purification unit is a three-bed system where one bed is in a feed phase, one bed is in a regeneration phase and one bed is in a stand-by phase.

11. The continuous purification method of claim 1, wherein the cryogenic separation unit produces at least one product selected from high-purity CO, synthesis gas with a specified H₂:CO ratio, crude hydrogen, and methane-rich fuel.

12. A continuous purification method of a synthesis gas to remove substantially all H₂O and CO₂ prior to routing said synthesis gas to a cryogenic separation unit, comprising:
supplying a synthesis gas feed stream obtained from a pre-purification unit to a synthesis gas purification unit comprised of at least two adsorbent beds undergoing a temperature swing adsorption (TSA) cycle where each bed undergoes at least two phases: (1) a feed phase for producing a synthesis gas product stream substantially free of H₂O and CO₂ by adsorbing these components on the adsorbent bed and (2) a regeneration phase to desorb H₂O and CO₂ from the adsorbent bed using a regeneration gas;
forming a regeneration gas stream by routing a regeneration portion of the synthesis gas product stream through a compressor where the regeneration gas stream is used to regenerate the adsorbent bed in the regeneration phase;
routing the regeneration gas leaving the adsorbent bed in the regeneration phase to upstream of the pre-purification unit;
stopping the flow of regeneration gas to the adsorbent bed after it is regenerated, depressurizing the adsorbent bed and introducing a portion of the synthesis gas feed stream to the second adsorbent bed to cool it to substantially the same temperature as the synthesis gas feed stream, wherein, during depressurization and subsequent cooling, the gas stream exiting the product end of the adsorbent bed is combined with the regeneration portion of the synthesis gas product stream and the combined gas mixture is compressed in the compressor forming the regeneration gas which is routed upstream of the pre-purification unit thus bypassing the regenerated bed.

13. The continuous purification method of claim 12, wherein the regeneration phase of the TSA cycle comprises at least a heating step, a cooling step, and a final cooling step.

14. The continuous purification method of claim 13, further comprising heating the regeneration gas in a heater during a heating step of the TSA cycle and sending said regeneration gas to the adsorbent bed undergoing the regeneration phase.

15. The continuous purification method of claim 13, further comprising stopping the addition of heat to the regeneration gas heater during a cooling step of the TSA cycle to cool the heater.

16. The continuous purification method of claim 13, further comprising by-passing the regeneration gas heater during a cooling step of the TSA cycle and sending the adsorbent bed undergoing the regeneration phase.

17. An integrated apparatus for continuous purification of a synthesis gas to remove substantially all H₂O and CO₂ prior to routing the synthesis gas product stream to a downstream cryogenic separation unit, comprising:
a synthesis gas purification unit comprised of at least two adsorbent beds undergoing a temperature swing adsorption (TSA) cycle wherein the adsorbent beds alternately undergo a feed phase during which an adsorbent bed purifies a synthesis gas feed stream and produces a synthesis gas product stream substantially free of H₂O and CO₂ and a regeneration phase during which an adsorbent bed is regenerated using a regeneration portion of the synthesis gas product stream;
a conduit arrangement and valves for routing the synthesis gas product stream to a cryogenic separation unit;
a compressor and heater disposed in series;
a conduit for routing a regeneration portion of the synthesis gas product stream to the low-pressure side of the compressor to form a regeneration gas;
a conduit arrangement and valves for routing the regeneration gas through a heater, for by-passing the heater, and for routing the regeneration gas upstream of the pre-purification unit;
a conduit arrangement and valves for routing the regeneration gas to the product end of the adsorbent beds;
a conduit arrangement and valves for withdrawing gas from the feed end of the adsorbent beds and routing gas to upstream of the pre-purification unit; and
a conduit arrangement and valves for withdrawing a synthesis gas stream from the product end of the adsorbent beds and routing the gas stream to the conduit for routing a regeneration portion of the synthesis gas product stream to the low-pressure side of the compressor.

18. The continuous purification method of claim 17, wherein materials of construction for the heater and piping is made of austenitic steels to reduce the rate of contamination formation.
